(19) United States
(12) Patent Application Publication
(10) Pub. No.: US 2010/0040856 A1
(43) Pub. Date: Feb. 18, 2010

(54) Colored strands and use thereof

(76) Inventors: Kurt-Günter Berndt, Graben (DE); Rex Delker, Wehringen (DE)

Correspondence Address: FERRELLS, PLLC, P. O. BOX 312, CLIFTON, VA, 20124-1706, US

(21) Appl. No.: 12/462,158

(22) Filed: Jul. 30, 2009

(30) Foreign Application Priority Data
Aug. 18, 2008 (DE) 10 2008 038 099.7

(51) Int. Cl. B32B 5/00; C08K 5/092; C08K 5/3415

(52) U.S. Cl. 428/221; 524/320; 524/104

(57) ABSTRACT

Strands comprise a) a selected thermoplastic elastomeric polymer and b) a perylene pigment.

These strands are very useful for interior trim equipment of vehicles, in office chair covers or in functional apparel. They combine low abrasion with low thermal absorption.

### CLAIM FOR PRIORITY

This application is based upon German Patent Application No. DE 10 2008 038 099.7, entitled “Gefärbte Fäden und deren Verwendung”, filed Aug. 18, 2008. The priority of German Patent Application No. DE 10 2008 038 099.7 is hereby claimed and its disclosure incorporated herein by reference.

### TECHNICAL FIELD

The present invention relates to strands which are colored with selected pigments and which are very useful in vehicles, for office chairs and for functional apparel. The strands combine reduced thermal absorption with low abrasion.

### BACKGROUND

Strands of thermoplastic elastomers are often colored with carbon black to obtain an antistatic effect as well as coloration. Such strands are used for example as components of the textile interior trim of vehicles. It has emerged that the use of carbon black is not unproblematic. Strands colored with carbon black have limited resistance to abrasion and the black coloration with carbon black leads in the event of direct insolation to a high thermal absorption on the part of the strand, and this in turn has a disadvantageous effect on climate control in the vehicle's interior.

Peylene pigments are already known for use as colorants for strands. DE 698 04 440 T2, for instance, describes solution-dyed and stabilized nylon fibers. These contain a selected sterically hindered piperidine compound as a stabilizer as well as at least one pigment, including a perylene pigment.

Processes for dyeing textile fibers from the liquor are known from DE-A-1 469 694, DE-A-1 619 607 and DE-A-29 12 497. Perylene pigments can be used inter alia.

DE-A-27 32 586 describes the solution dyeing of linear polyesters by use of a mixture of colorants wherein one component is a perylenetetracarboxylic acid derivative. The colorations obtained in the linear polyesters are bright, strong in color and very lightfast.

DE 38 14 647 A1 describes polymeric perylene dyes which have a high dielectric constant and are useful as a dielectric in capacitors, particularly for applications in the radio frequency range.

DE 10 2005 049 297 A1 discloses thermoplastic molding compositions comprising thermoplastic polyamide, red phosphorus and a melamine compound. An impact modifier can also be used, according to this document. Examples of an impact modifier include customary elastomers which have already been used for this purpose.

DE 101 62 348 A1 describes a process for applying functional materials to thermoplastically elastomeric polyurethanes.

DE 199 57 899 A1 discloses thermoplastic molding compositions comprising thermoplastic polymer, cerium-containing white pigment and further colorant. Thermoplastically elastomeric polyurethanes are recited as thermoplastic polymers.

DE 199 30 527 A1 describes thermoplastic molding compositions comprising thermoplastic polyester, polycarbonate, rubber-elastic polymer, phosphorus-containing stabilizer and organic acid. A wide range of compounds are recited in this document for use as rubber-elastic polymers.

### SUMMARY OF INVENTION

It is an object of the present invention to provide strands that combine very good elastic properties with an intensive and lightfast coloration and also possess good resistance to abrasion and also low absorption in the infrared range. These strands shall be distinctly less prone to heat up, compared with carbon black-colored strands, on irradiation with sunlight or with radiation which includes portions of infrared. In addition, the strands shall possess high extensibility.

It has now been found that, surprisingly, a soft polymer in the form of a selected thermoplastic elastomeric polymer and a perylene pigment can be processed to form strands that do have the advantageous combination of properties set out above.

### DETAILED DESCRIPTION

The invention is described in detail below with reference to several embodiments and numerous examples. Such discussion is for purposes of illustration only. Modifications to particular examples within the spirit and scope of the present invention, set forth in the appended claims, will be readily apparent to one of skill in the art. Terminology used herein is given its ordinary meaning consistent with the exemplary definitions set forth immediately below.

The present invention accordingly provides strands comprising a) a thermoplastic elastomeric polymer selected from the group of thermoplastic elastomeric polyesters (TPE-E), of thermoplastic elastomeric polyamides (TPE-A), of thermoplastic elastomeric styrene block copolymers (TPE-S), and combinations of two or more thereof, and b) a perylene pigment.

The thermoplastic elastomeric polymers used according to the present invention are the types mentioned above. Such polymers are known to those skilled in the art.

The thermoplastic elastomeric polymers are typically block copolymers which may be constructed from different combinations of monomers. The blocks generally comprise hard segments and soft segments. Soft segments typically derive from polyalkylene glycols in the case of TPE-E and TPE-A. Hard segments typically derive from short-chain diols or diamines in the case of TPE-E and TPE-A. As well as from diols/diamines, the hard and soft segments are constructed from aliphatic, cycloaliphatic and/or aromatic dicarboxylic acids.

Polyethylene glycol, polypropylene glycol and/or polybutylene glycol are particularly suitable polyalkylene glycols.

Particularly suitable short-chain diols are aliphatic and/or cycloaliphatic diols, for example ethylene glycol, propanediol, 1,4-butanediol, 1,4-cyclohexanedimethanol or mixtures thereof. Preference is given to aliphatic diols having two to four carbon atoms, particularly ethylene glycol and butanediol. Preference is further given to cycloaliphatic diols, such as 1,4-cyclohexanedimethanol.

Particularly suitable short-chain diamines are aliphatic and/or aromatic diamines, for example tetramethylenediamine, hexamethylenediamine, nonamethylenediamine, undecamethylenediamine, dodecamethylenediamine, xylylenediamine. Hexamethylenediamine is a preferred diamine.

The dicarboxylic acids mentioned above are a further constructional element of the thermoplastic elastomeric polyesters or polyamides. Aliphatic, cycloaliphatic and/or aromatic dicarboxylic acids are concerned, examples being adipic acid, sebacic acid, terephthalic acid, cyclohexanedicarboxylic acid, isophthalic acid, dodecanedicarboxylic acid, glutaric acid. Terephthalic acid, sebacic acid or cyclohexanedicarboxylic acid are the main acid constituent of the block copolymers.

Examples of thermoplastic elastomeric styrene block copolymers are block copolymers which include blocks of styrene-ethylene and of propylene-styrene (SEPS) or of styrene-ethylene and of butadiene-styrene (SEBS), or of styrene and of butadiene (SBS).

Thermoplastic elastomeric polymers herein are polymers that have similar room temperature behavior to classic elastomers but are plastically deformable on heating and thus display thermoplastic behavior. These thermoplastic elastomeric polymers have subregions with physical points of crosslinking (for example secondary valency forces or crystallites) which become unlinked on heating without the polymer molecules decomposing.

Perylene pigments useful for producing the strands of the present invention are known to a person skilled in the art.

Useful perylene pigments include any compounds of basic perylene structure which, on incorporation into a matrix containing thermoplastic elastomeric polymers or application to the surface of a strand composed of these polymers, produce a coloration of the polymer.

Particularly useful classes of perylene pigments are perylene itself, i.e., peri-dinaphthylene, and perylene derivatives. Examples of perylene derivatives are tetracarboxylic acids of perylene and their derivatives, such as dianhydrides, diimides including bis-N-hydrocarbyldiimides such as bis-N-alkyldiimides, tetracarboxylic esters or tetracarboxylic amides; di-, tri- or tetraalkyl derivatives of perylene, di- or tetraketones of perylene, di-, tri- or tetrahydroxy derivatives of perylene, di-, tri- or tetraethers of perylene.

Particular preference is given to using perylene, 3,4,9,10-perylenetetracarboxylic acids, 3,4,9,10-tetracarboxylic dianhydride, 3,4,9,10-tetracarboxylic diimide and/or N,N′dimethyl-3,4,9,10-tetracarboxylic diimide.

The perylene pigment selected for use in any particular case depends on its compatibility with the polymer matrix and the particular hue desired for the strand. The selection criteria therefor are known to a person skilled in the art.

The perylene pigment in the strands of the present invention can be used alone or in the form of mixtures optionally in combination with further pigments. The perylene pigments can be used for example in the form of dry pigments, liquid pigments, encapsulated pigments, pigment dispersions or most preferably in the form of a masterbatch with a carrier polymer, for example a polyolefin or one of the abovementioned thermoplastic elastomeric polymers.

Introducing the perylene pigment into the thermoplastic elastomeric polymer or applying the perylene pigment onto the thermoplastic elastomeric polymer can be carried out by following various methods described in the prior art. These include, for example, mixing the perylene pigment with the polymer, dissolving and/or dispersing the perylene pigment in the polymer and applying the perylene pigment as an overcoat to the surface of a strand composed of thermoplastically elastomeric polymer.

In one preferred embodiment, the composition of the present invention further, in addition to said components a) and b), comprises a component c), a polymer having a melting point in the range or below the melting point of the thermoplastically elastomeric polymer of said component a), preferably at least 10° C. below the melting point of the thermoplastically elastomeric polymer of component a).

Component c) comprises selected polymers. Typically, what is concerned is the polymer component of a masterbatch used in the preparation of the compositions of the present invention. To ensure sufficient formability and miscibility in the extruder, the melting point of the polymer of component c) should be in the range of the melting point or preferably at least 10° C. below the melting point of the polymer of component a).

Examples of suitable polymers for component c) are polyesters, polyamides, polyolefins, such as polyethylene or polypropylene, or thermoplastic elastomeric polymers. The latter are particularly preferred. It is very particularly preferred for a masterbatch to contain the same type of polymer as the polymer of component a), for example a TPE-E when component a) is a TPE-E.

The perylene pigments are in a state of dispersion in the masterbatch used according to the present invention. The masterbatch here is incorporated in the polymer matrix in the course of the production of the strand. The perylene molecules color the strand. It has been determined that, surprisingly, the perylene pigment does color the strand, yet, on the other hand, absorbs thermal radiation to a limited extent only, and therefore the strand heats up less on insolation than would be the case with carbon black coloration. It has also emerged that the strands thus colored do have good abrasion resistance.

The compositions of the present invention, in addition to components a), b) and optionally c), may comprise further, additive materials d).

Examples thereof are hydrolysis stabilizers, processing aids, antioxidants, UV stabilizers, plasticizers, lubricants, further pigments, viscosity modifiers or crystallization accelerants.

Examples of hydrolysis stabilizers are carbodiimides or epoxidized compounds.

Examples of processing aids are siloxanes, waxes, or comparatively long-chain carboxylic acids or their salts, aliphatic, aromatic esters or ethers.

Examples of antioxidants are phosphorus compounds, such as phosphoric esters or sterically hindered phenols.

Examples of UV stabilizers are UV-absorbing compounds, such as benzophenones or benztriazoles, or compounds of the HALS type (“hindered amine light stabilizer”).

An example of a plasticizer is dioctyl phthalate.

Examples of lubricants are polyolefin waxes.

Examples of further pigments or delusterants are organic dye pigments or titanium dioxide.

Examples of viscosity modifiers are polybasic carboxylic acids and their esters or polyhydric alcohols.

The strands of the present invention are obtainable in a conventional manner, for example by extruding the plasticated polymer mass through a spinneret die and, after the strand formed has cooled down, subsequently subjecting it to conventional drawing and relaxing steps.

In one preferred embodiment, the perylene pigment is incorporated in a masterbatch additionally containing a polymer such as component a) or a different polymer of component c) into the polymer a) for producing the strand.

The term “strands” herein is to be understood as referring very generally to fibers of finite length (staple fibers), fibers of infinite length (filaments) and also multifilaments composed thereof, or yarns secondarily spun from staple fibers. Preference is given to melt-spun strands in the form of monofilaments.

“Monofilaments” herein are individual strands. Their diameter is typically in the range from 0.055 to 2.00 mm and preferably in the range from 0.10 to 0.60 mm.

In a particularly preferred embodiment, the strands of the present invention are present as monofilaments.

The linear density of the strands of the present invention can vary within wide limits. Examples thereof are 1 to 45 000 dtex, particularly 100 to 4000 dtex.

The cross-sectional shape of the strands of the present invention is freely choosable, examples being round, oval or n-gonal, where n is not less than 3.

The amounts of components a), b) and optionally c) and/or optionally d) in the strands of the present invention can be chosen within wide limits.

Typically, the strand of the present invention contains 70% to 99.999% by weight, preferably 95% to 99.98% by weight, of component a), based on the total mass of the strand. The amount of component a) in the strand of the present invention is selected by a person skilled in the art as a function of the intended use and/or the contemplated processing.

The amount of perylene pigment b) in the strand of the present invention is likewise chosen by a person skilled in the art as a function of the intended use and/or the contemplated processing.

The amount of perylene pigment in the strand of the present invention is typically in the range from 0.0001% to 5% by weight, based on total mass of the strand, preferably the amount of perylene pigment is in the range from 0.001% to 1% by weight, particularly in the range from 0.01% to 0.5% by weight and more preferably in the range from 0.02% to 0.1% by weight.

The amount of the optional component c) in the strand of the present invention is likewise selected by a person skilled in the art as a function of the intended use and/or the contemplated processing.

The amount of this component is typically in the range from 0% to 25% by weight, based on the total mass of the strand.

Similarly, the proportion of the optionally used additive materials d) is selected by a person skilled in the art according to the intended use and/or the contemplated processing. The proportion of component d) is typically up to 20% by weight and preferably up to 10% by weight, based on the total mass of the strand.

The components a), b), optionally c) and/or optionally d) which are needed to produce the strands of the present invention are known per se, commercially available in some instances, or obtainable by following processes known per se.

The strands of the present invention are preferably used in the manufacture of textile fabrics, particularly woven fabrics, laid scrim fabrics, loop-formingly knit fabrics, braided fabrics or loop-drawingly knit fabrics.

The strands of the present invention are useful for example for textile interior trim equipment of land, water or air vehicles, more preferably for textile interior trim equipment of automobiles and military vehicles. Further preferred uses are the use in office chair covers and in functional apparel.

These uses likewise form part of the subject matter of the present invention.

The present invention is more particularly described in the example which follows, which merely serves as elucidation and not as restriction.

### EXAMPLE 1

A thermoplastic elastomeric polyester in chip form (Heraflex E 5620; from Radicinovapics S.p.A., Chignolo d'Isola, Italy) was used on a melt-spinning range for production of monofilaments. Prior to the spinning operation, 8% by weight of a masterbatch (Lifocolor Black 9000169 TPE; from Lifocolor Farben GmbH & Co, KG, Lichtenfels, Germany) was gravimetrically admixed, in the descending pipe of the extruder, into the stream of TPE-E chips. The mixture was melted in the extruder, fed via a spinning pump to a spin pack, spun through fine drill-holes to form monofilaments, which were quenched in a waterbath, subsequently drawn in three stages with heating, spin finished and wound up on flange bobbins.

The Lifocolor Black 9000169 TPE masterbatch was a compound of a perylene pigment in thermoplastic elastomeric polyester.

The monofilaments obtained had the following fiber properties:

| | |
|---|---|
| Diameter | 0.30 mm |
| Tenacity | 28 cN/tex |
| Elongation at break | 43% |
| Free thermal shrinkage | 45% |
| at 160° C. | |

The monofilaments obtained possessed a marked black color combined with distinctly lower thermal absorption, compared with comparable monofilaments colored with carbon black.

While the sample with carbon black pigment reached a temperature of 80° C. after 40 minutes, the sample with perylene pigment remained distinctly below this value when exposed to the same irradiation and irradiation time at 55° C. A further identical monofilament with titanium dioxide as pigment is listed for comparison. It reached a temperature of 51° C. after a heating time of 40 minutes. The temperatures of the strands on irradiation are reported in the table below.

TABLE 1
Temperature of the Strands on Irradiation

| | Time (min) | | | | |
|---|---|---|---|---|---|
| | 0 | 10 | 20 | 30 | 40 |
| Sample with | 22° C. | 45° C. | 52° C. | 54° C. | 55° C. |
| perylene pigment | | | | | |
| (invention) | | | | | |
| Sample with | 22° C. | 60° C. | 73° C. | 75° C. | 80° C. |
| carbon black | | | | | |
| (comparison) | | | | | |
| Sample with | 22° C. | 42° C. | 50° C. | 51° C. | 51° C. |
| titanium dioxide | | | | | |
| (comparison) | | | | | |

While the invention has been described in detail, modifications within the spirit and scope of the invention will be readily apparent to those of skill in the art. In view of the foregoing discussion, relevant knowledge in the art and references discussed above in connection with the Background and Detailed Description, the disclosures of which are all incorporated herein by reference, further description is deemed unnecessary. In addition, it should be understood that aspects of the invention and portions of various embodiments may be combined or interchanged either in whole or in part. Furthermore, those of ordinary skill in the art will appreciate that the foregoing description is by way of example only, and is not intended to limit the invention.

What is claimed is:

1. A strand comprising:
a) a thermoplastic elastomeric polymer selected from the group consisting of: thermoplastic elastomeric polyesters; thermoplastic elastomeric polyamides; thermoplastic elastomeric styrene block copolymers; or from mixtures of two or more of these polymers; and
b) a perylene pigment.

2. The strand according to claim 1, wherein the thermoplastic elastomeric polymer is a thermoplastic elastomeric polyester.

3. The strand according to claim 2, wherein the thermoplastic elastomeric polyester derives from an aliphatic, cycloaliphatic and/or aromatic dicarboxylic acid and an aliphatic and/or cycloaliphatic diol and also from a polyalkylene glycol.

4. The strand according to claim 1, wherein the perylene pigment is incorporated in a matrix comprising the thermoplastic elastomeric polymer and/or applied to the surface of the fiber composed of the thermoplastic elastomeric polymer.

5. The strand according to claim 1, wherein the perylene pigment is perylene, perylenetetracarboxylic dianhydride and/or perylenetetracarboxylic diimide.

6. The strand according to claim 1 further comprising a component c), a polymer having a melting point in the range or below the melting point of the thermoplastically elastomeric polymer of said component a).

7. The strand according to claim 1, comprising further, one or more additive materials d).

8. The strand according to claim 7, wherein the further additive materials d) are selected from the group of hydrolysis stabilizers, processing aids, antioxidants, UV stabilizers, plasticizers, lubricants, pigments, electroconductive additives, viscosity modifiers, crystallization accelerants, or from combinations of two or more thereof.

9. The strand according to claim 1, wherein the perylene pigment is included in amounts from 0.001% to 0.1% by weight, preferably 0.02% to 0.06% by weight.

10. The strand according to claim 1, as a monofilament.

11. A method of making a textile fabric comprising:
a) preparing a strand comprising (i) a thermoplastic elastomeric polymer selected from the group consisting of: thermoplastic elastomeric polyesters; thermoplastic elastomeric polyamides; thermoplastic elastomeric styrene block copolymers; or from mixtures of two or more of these polymers; and (ii) a perylene pigment; and
b) incorporating the strand into a textile fabric.

12. The method of making a textile fabric according to claim 11, wherein the fabric is selected from: woven fabrics; laid scrim fabrics, loop-formingly knit fabrics, braided fabrics or loop-drawingly knit fabrics.

13. A textile fabric incorporating a strand comprising a) a thermoplastic elastomeric polymer selected from the group consisting of: thermoplastic elastomeric polyesters; thermoplastic elastomeric polyamides; thermoplastic elastomeric styrene block copolymers; or from mixtures of two or more of these polymers; and b) a perylene pigment.

14. The textile fabric according to claim 13, wherein the fabric is incorporated into an office chair cover or is incorporated into functional apparel.

15. The textile fabric according to claim 13, wherein the fabric is incorporated into textile interior trim equipment of a land, water or air vehicle.

16. The textile fabric according to claim 13, wherein the fabric is incorporated into textile interior trim equipment of an automobile or military vehicle.
